(19) United States
(12) Patent Application Publication
(10) Pub. No.: US 2012/0199411 A1
(43) Pub. Date: Aug. 9, 2012

(54) VARIABLE DISPLACEMENT PUMP

(75) Inventors: Satoshi NONAKA, Yokote-shi (JP); Makoto Kimura, Yokohama-shi (JP)

(73) Assignee: UNISIA JKC STEERING SYSTEMS CO., LTD.

(21) Appl. No.: 13/306,558

(22) Filed: Nov. 29, 2011

(30) Foreign Application Priority Data
Feb. 7, 2011 (JP) 2011-023523

(51) Int. Cl. B62D 5/06

(52) U.S. Cl. 180/422

(57) ABSTRACT

A variable displacement pump includes a pumping part and a cam ring for supplying working fluid to a vehicle steering device. The cam ring is arranged radially outside of the pumping part, and configured to move along with a change in eccentricity of the cam ring, wherein the change in eccentricity causes a change in specific discharge rate. A solenoid is configured to control the eccentricity of the cam ring by being driven with an energizing current conformed to a control setpoint. A base setpoint is calculated based on steering angular speed and vehicle speed. The control setpoint is calculated based on the base setpoint and steering angular acceleration in a manner that the control setpoint increases more quickly than the base setpoint when the base setpoint increases in accordance with steering operation of the steering wheel.

### BACKGROUND OF THE INVENTION

The present invention relates generally to variable displacement pumps, and more particularly to variable displacement pumps for supplying working fluid to an automotive hydraulic power steering system.

Japanese Patent Application Publication No. 2007-092761 discloses a variable displacement pump for supplying working fluid to an automotive hydraulic power steering system. This variable displacement pump is configured to control eccentricity of a cam ring with respect to a rotor by operating a solenoid, and thereby control the specific discharge rate of the variable displacement pump. The solenoid is controlled based on a vehicle speed signal and a steering angle signal, wherein the vehicle speed signal is obtained by a vehicle speed sensor provided at road wheels or the like, and the steering angle signal is obtained by a steering angle sensor provided at the steering system. The feature of variable displacement serves to reduce a torque required to rotate the rotor, and thereby save energy.

### SUMMARY OF THE INVENTION

In the case of the variable displacement pump disclosed in Japanese Patent Application Publication No. 2007-092761, the control of the solenoid based on the vehicle speed signal and the steering angle signal may fail to quickly increase the pump discharge rate when quick increase of the pump discharge rate is desired in response to abrupt steering or the like.

In view of the foregoing, it is desirable to provide a variable displacement pump which is capable of supplying a suitable quantity of working fluid without delay, especially when quick increase of the pump discharge rate is desired in response to abrupt steering or the like.

According to one aspect of the present invention, a variable displacement pump for supplying working fluid to a vehicle steering device, wherein the vehicle steering device is configured to hydraulically generate an assist steering force in accordance with steering operation of a steering wheel, comprises: a pump housing including a pumping part housing section inside the pump housing; a drive shaft rotatably supported by the pump housing; a pumping part housed in the pumping part housing section of the pump housing, and configured to suck and discharge working fluid by being rotated by the drive shaft; a cam ring housed in the pumping part housing section of the pump housing, and arranged radially outside of the pumping part, and configured to move along with a change in eccentricity of the cam ring with respect to an axis of rotation of the drive shaft, wherein the change in eccentricity causes a change in specific discharge rate, wherein the specific discharge rate is a quantity of discharge of working fluid per one rotation of the pumping part; a solenoid configured to control the eccentricity of the cam ring by being driven with an energizing current conformed to a control setpoint; a base setpoint calculation circuit configured to calculate a base setpoint based on steering angular speed and vehicle speed, wherein the steering angular speed is angular speed of rotation of the steering wheel; and a control setpoint calculation circuit configured to calculate the control setpoint based on the base setpoint and steering angular acceleration in a manner that the control setpoint increases more quickly than the base setpoint when the base setpoint increases in accordance with steering operation of the steering wheel, wherein the steering angular acceleration is angular acceleration of rotation of the steering wheel.

According to another aspect of the present invention, a variable displacement pump for supplying working fluid to a vehicle steering device, wherein the vehicle steering device is configured to hydraulically generate an assist steering force in accordance with steering operation of a steering wheel, comprises: a pump housing including a pumping part housing section inside the pump housing; a drive shaft rotatably supported by the pump housing; a pumping part housed in the pumping part housing section of the pump housing, and configured to suck and discharge working fluid by being rotated by the drive shaft; a cam ring housed in the pumping part housing section of the pump housing, and arranged radially outside of the pumping part, and configured to move along with a change in eccentricity of the cam ring with respect to an axis of rotation of the drive shaft, wherein the change in eccentricity causes a change in specific discharge rate, wherein the specific discharge rate is a quantity of discharge of working fluid per one rotation of the pumping part; and a solenoid configured to control the eccentricity of the cam ring by being driven with an energizing current conformed to a control setpoint, wherein: a base setpoint is calculated based on steering angular speed and vehicle speed, wherein the steering angular speed is angular speed of rotation of the steering wheel; and the control setpoint is calculated based on the base setpoint and steering angular acceleration in a manner that the control setpoint increases more quickly than the base setpoint when the base setpoint increases in accordance with steering to operation of the steering wheel, wherein the steering angular acceleration is angular acceleration of rotation of the steering wheel.

According to a further aspect of the present invention, a variable displacement pump for supplying working fluid to a vehicle steering device, wherein the vehicle steering device is configured to hydraulically generate an assist steering force in accordance with steering operation of a steering wheel, comprises: a pump housing including a pumping part housing section inside the pump housing; a drive shaft rotatably supported by the pump housing; a pumping part housed in the pumping part housing section of the pump housing, and configured to suck and discharge working fluid by being rotated by the drive shaft; a cam ring housed in the pumping part housing section of the pump housing, and arranged radially outside of the pumping part, and configured to move along with a change in eccentricity of the cam ring with respect to an axis of rotation of the drive shaft, wherein the change in eccentricity causes a change in specific discharge rate, wherein the specific discharge rate is a quantity of discharge of working fluid per one rotation of the pumping part; a solenoid configured to control the eccentricity of the cam ring by being driven with an energizing current conformed to a control setpoint; a base setpoint calculation circuit configured to calculate a base setpoint based on steering angular speed and vehicle speed, wherein the steering angular speed is angular speed of rotation of the steering wheel; and a control setpoint calculation circuit configured to: determine whether the steering angular to acceleration is above or below a predetermined threshold value; and calculate the control setpoint in a manner that the control setpoint increases more quickly when it is determined that the steering angular acceleration is above the predetermined threshold value than when it is determined that the steering angular acceleration is below the predetermined threshold value.

### BRIEF DESCRIPTION OF THE DRAWINGS

FIG. 1 is a schematic diagram showing system configuration of a variable displacement pump common to all of present embodiments of the present invention.

FIG. 2 is a block diagram showing device configuration of an electrical control unit of the variable displacement pump of FIG. 1.

FIG. 3 is a control block diagram showing logic configuration of the electrical control unit of FIG. 1 according to a first embodiment of the present invention.

FIG. 4 is a flow chart showing a control procedure of controlling an electromagnetic valve of the variable displacement pump of FIG. 1 according to the first embodiment.

FIGS. 5A to 5F are a set of time charts showing an example of how various quantities change with time under control based on the control procedure of FIG. 4.

FIG. 6 is a graph showing a relationship between vehicle speed and abrupt steering threshold value, on which the control procedure of FIG. 4 is based.

FIG. 7 is a graph showing a relationship between vehicle speed and correction discharge rate, on which the control procedure of FIG. 4 is based.

FIG. 8 is a graph showing a relationship between vehicle speed and pump discharge rate when no steering operation is inputted, on which the control procedure of FIG. 4 is based.

FIG. 9 is a control block diagram showing logic configuration of the electrical control unit of FIG. 1 according to a modification of the first embodiment.

FIG. 10 is a flow chart showing a control procedure of controlling the electromagnetic valve of FIG. 1 according to the modification of the first embodiment.

FIGS. 11A to 11E are a set of time charts showing an example of how various quantities change with time under control based on the control procedure of FIG. 10.

FIG. 12 is a control block diagram showing logic configuration of the electrical control unit of FIG. 1 according to a second embodiment of the present invention.

FIG. 13 is a flow chart showing a control procedure of controlling the electromagnetic valve of FIG. 1 according to the second embodiment.

FIG. 14 is a graph showing a relationship between steering angular acceleration and correction gain, on which the control procedure of FIG. 13 is based.

FIG. 15 is a flow chart showing a control procedure of controlling the electromagnetic valve of FIG. 1 according to a third embodiment of the present invention.

FIGS. 16A to 16F are a set of time charts showing an example of how various quantities change with time under control based on the control procedure of FIG. 15.

### DETAILED DESCRIPTION OF THE INVENTION

In the following embodiments, a variable displacement pump is configured to supply working fluid to an automotive hydraulic power steering system.

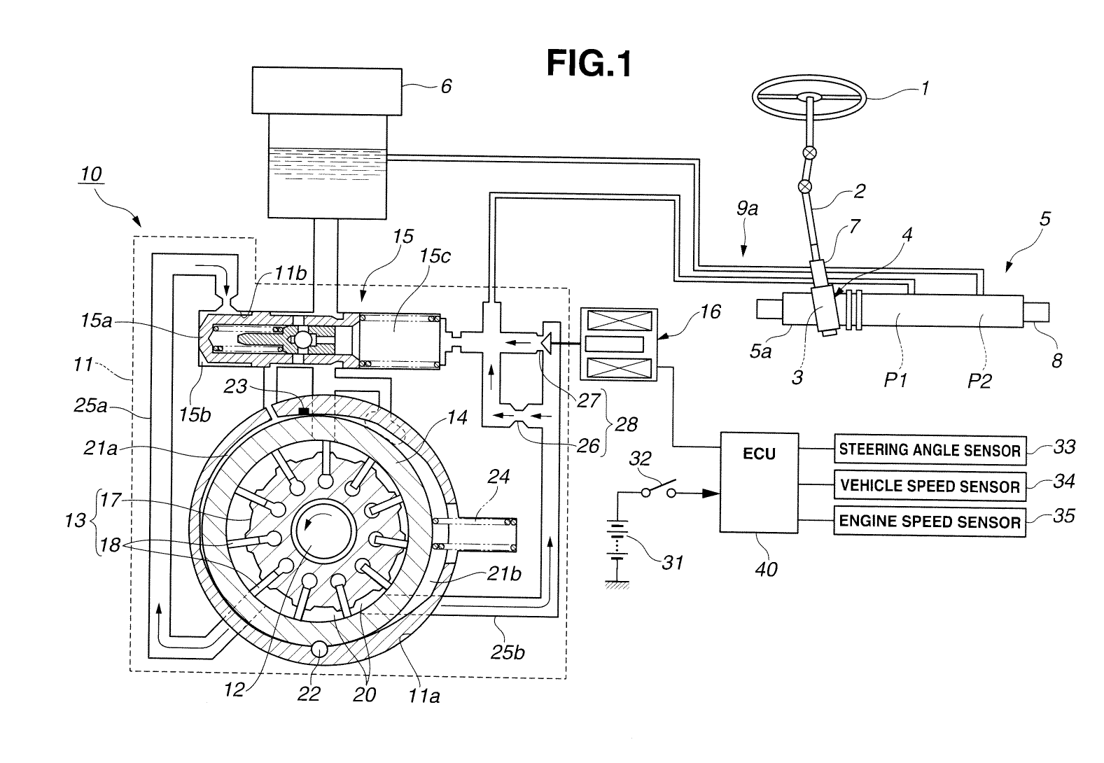

FIGS. 1 to 8 show a variable displacement pump according to a first embodiment of the present invention. First of all, the following describes the automotive hydraulic power steering system to which the variable displacement pump is applied. As shown in FIG. 1, the power steering system includes a steering wheel 1, an input shaft 2, an output shaft 3, a rack-and-pinion mechanism 4, a power cylinder 5, a reservoir tank 6, a control valve 7, a rack shaft 8, and a pump 10. Input shaft 2 has one end linked with steering wheel 1 so that steering wheel 1 and input shaft 2 rotate as a solid unit. Input shaft 2 receives input of driver's steering operation through the steering wheel 1. The other end of input shaft 2 is connected to a first end of output shaft 3 through a torsion bar not shown which allows relative rotation between input shaft 2 and output shaft 3. Output shaft 3 has a second end linked with steerable road wheels not shown through the rack-and-pinion mechanism 4. In this construction, output shaft 3 transmits steering torque through a reaction force resulting from torsional deformation of the torsion bar. Power cylinder 5 is arranged between output shaft 3 and the steerable road wheel set. Power cylinder 5 has first and second pressure chambers P1, P2 which are separated inside the power cylinder 5, and produces an assist steering torque for assisting or boosting the steering output of output shaft 3 based on fluid pressures of first and second pressure chambers P1, P2. Reservoir tank 6 stores working fluid which is supplied to power cylinder 5. Pump 10 sucks working fluid stored in reservoir tank 6, and supplies working fluid under pressure to first and second pressure chambers P1, P2 of power cylinder 5. Control valve 7 is opened and closed in accordance with relative rotation between input shaft 2 and output shaft 3, and is configured to control the amount of working fluid supplied to power cylinder 5 in accordance with the amount of relative rotation between input shaft 2 and output shaft 3, i.e. in accordance with the amount of torsion of the torsion bar.

Rack-and-pinion mechanism 4 includes a pinion gear not shown and a rack gear not shown in mesh with each other. The pinion gear is formed at the periphery of the lower end of output shaft 3, whereas the rack gear is formed at rack shaft 8 to extend in a some range in the longitudinal direction of rack shaft 8, wherein rack shaft 8 crosses the lower end of output shaft 3 substantially perpendicularly. Rotation of output shaft 3 causes leftward or rightward movement of rack shaft 8 as viewed in FIG. 1. This movement of rack shaft 8 pushes or pulls knuckles not shown each of which is linked with a corresponding one of the ends of rack shaft 8, and thereby steers the steerable road wheels.

Power cylinder 5 includes a cylinder tube 5a which has a substantially cylindrical shape. Rack shaft 8 serves as a piston rod extending through the cylinder tube 5a longitudinally of cylinder tube 5a. The internal space of cylinder tube 5a is separated by a piston not shown into first and second pressure chambers P1, P2, wherein the piston is fixed to the periphery of rack shaft 8. Fluid pressures in first and second pressure chambers P1, P2 produce a thrust applied to rack shaft 8, and thereby assist the steering output. First and second pressure chambers P1, P2 are connected to reservoir tank 6 and pump 10 through first to fourth lines 9a and control valve 7. The working fluid discharged from pump 10 is supplied through control valve 7 to one of first and second pressure chambers P1, P2 selectively, whereas the working fluid in the other one of first and second pressure chambers P1, P2 is drained and returned to reservoir tank 6.

Pump 10 is a vane-type variable displacement pump, which includes a pump housing 11, a drive shaft 12, a pumping part 13, a cam ring 14, a control valve 15, and an electromagnetic valve 16. Pump housing 11 has a pumping part housing section 11a inside of pump housing 11. Pumping part housing section 11a is a substantially cylindrical space. Drive shaft 12 is rotatably supported by pump housing 11, and driven and rotated by a driving torque of an engine not shown. Pumping part 13 is housed in pumping part housing section 11a of pump housing 11, and is driven by drive shaft 12 to rotate in a counterclockwise direction as viewed in FIG. 1, and perform a pumping function of sucking and discharging working fluid. Cam ring 14 is substantially annularly shaped, and is housed in pumping part housing section 11a of pump housing 11, and is arranged radially outside of pumping part 13, and is configured to move along with a change in displacement or eccentricity of cam ring 14 with respect to an axis of rotation of drive shaft 12, wherein the change in eccentricity causes a change in specific discharge rate, wherein the specific discharge rate is a quantity of discharge of working fluid per one rotation of pumping part 13. Control valve 15 is housed in pump housing 11, and is configured to control the eccentricity of cam ring 14 by changing the differential pressure between first and second fluid pressure chambers 21a, 21b in accordance with an axial position of a valve element 15a which is slidably mounted inside a valve hole 11b formed in pump housing 11. Electromagnetic valve 16 is a solenoid housed and fixed in pump housing 11, and is configured to control the specific discharge rate by changing the differential pressure between first and second pressure chambers 15b, 15c in accordance with a control current which is outputted from an electrical control unit (ECU) 40.

Pumping part 13 is arranged radially inside of cam ring 14, and is rotatably supported by pump housing 11. Pumping part 13 includes a rotor 17, and a plurality of vanes 18. Rotor 17 is driven and rotated by drive shaft 12. Rotor 17 is formed with a plurality of slots at the periphery of rotor 17 which are arranged evenly spaced and extend radially outwardly. Each vane 18 has a substantially rectangular shape and is retained in a corresponding one of the slots for forward and backward movement. When rotor 17 is rotating, each vane 18 is urged outwardly to project from the slot into sliding contact with the inner lateral surface of cam ring 14, and separate the space between cam ring 14 and rotor 17 into a plurality of pump chambers 20.

Cam ring 14 is formed with a recess at the periphery. The recess has a semicircular cross section, and serves as a support recess through which cam ring 14 is positioned and supported by a swing pivot pin 22. Cam ring 14 is configured to swing about swing pivot pin 22 leftward or rightward as viewed in FIG. 1. This movement of cam ring 14 causes a change in the volumetric capacity of each pump chamber 20, and thereby causes a change in the specific discharge rate. Pump housing 11 includes a recess retaining a seal 23 outside of cam ring 14. Seal 23 is located substantially opposite to swing pivot pin 22 with respect to cam ring 14 in the radial direction. Swing pivot pin 22 and seal 23 are in contact with cam ring 14, and separate the space outside of cam ring 14 into first fluid pressure chamber 21a on the left side and second fluid pressure chamber 21b on the right side as viewed in FIG. 1. First and second fluid pressure chambers 21a, 21b serve to control the swinging motion of cam ring 14. Cam ring 14 is applied not only with the pressures of first and second fluid pressure chambers 21a, 21b, but also with a spring force of a coil spring 24 that is arranged in second fluid pressure chamber 21b. The spring force of coil spring 24 constantly biases cam ring 14 in the direction from second fluid pressure chamber 21b to first fluid pressure chamber 21a, i.e. in the direction to increase the eccentricity of cam ring 14 toward a maximum setpoint.

Control valve 15 includes valve element 15a which is slidably mounted in valve hole 11b of pump housing 11. Valve element 15a separates the internal space of valve hole 11b into a first pressure chamber 15b on the left side and a second pressure chamber 15c on the right side as viewed in FIG. 1. First pressure chamber 15b is applied with a fluid pressure of an upstream side of electromagnetic valve 16, whereas second pressure chamber 15c is applied with a fluid pressure of a downstream side of electromagnetic valve 16. Specifically, pump housing 11 is formed with a discharge passage at the discharge side (on the right side as viewed in FIG. 1) of pumping part housing section 11a, wherein the discharge passage communicates with pump chambers 20 located at the discharge side. The discharge passage is branched into a first discharge passage 25a and a second discharge passage 25b. First discharge passage 25a is connected to first pressure chamber 15b of control valve 15 so that first pressure chamber 15b is applied with a discharge pressure. On the other hand, second discharge passage 25b opens to the outside on the downstream side of electromagnetic valve 16 that is provided at an intermediate point of second discharge passage 25b, and is connected to second pressure chamber 15c. Second pressure chamber 15c and the outside are applied with a fluid pressure that is reduced by electromagnetic valve 16. In this construction, when valve element 15a is displaced to the left side as viewed in FIG. 1, first fluid pressure chamber 21a is applied with a suction pressure (low pressure) so that cam ring 14 is held with the eccentricity maintained at the maximum setpoint by the spring force of coil spring 24. On the other hand, when valve element 15a is displaced to the right side as viewed in FIG. 1, first fluid pressure chamber 21a is applied with the discharge pressure (high pressure) so that cam ring 14 is pressed to move along with a decrease in the eccentricity against the spring force of coil spring 24.

Electromagnetic valve 16 is electrically connected to on-board ECU 40, and is driven under control by ECU 40 based on information inputted to ECU 40, wherein the information is about steering angle, vehicle speed, engine speed, steering angular acceleration, etc., wherein the steering angular acceleration is calculated based on the steering angle. Electromagnetic valve 16 is provided with a variable metering orifice 28 inside, wherein variable metering orifice 28 is composed of a constant orifice 26 and a variable orifice 27. On the basis of the information inputted to ECU 40, electromagnetic valve 16 is made to regulate the cross-sectional area of variable orifice 27, and thereby regulate the differential pressure between the upstream and downstream sides of variable metering orifice 28, i.e. the differential pressure between first and second pressure chambers 15b, 15c of control valve 15, and thereby control the axial position of valve element 15a of control valve 15, and thereby control the eccentricity of cam ring 14, and thereby control the specific discharge rate.

ECU 40 is supplied with electric power from an on-board battery 31 through an ignition switch 32. ECU 40 is connected to various sensors for obtaining information from the sensors, wherein the sensors include a steering angle sensor 33 for sensing the steering angle of steering wheel 1, a vehicle speed sensor 34 for sensing vehicle speed, and an engine speed sensor 35 for sensing engine speed. Steering angle sensor 33 is provided at input shaft 2 of the power steering system. Vehicle speed sensor 34 is provided at a brake control device not shown and is composed of sensors provided for respective road wheels. Engine speed sensor 35 is provided at an engine control device not shown.

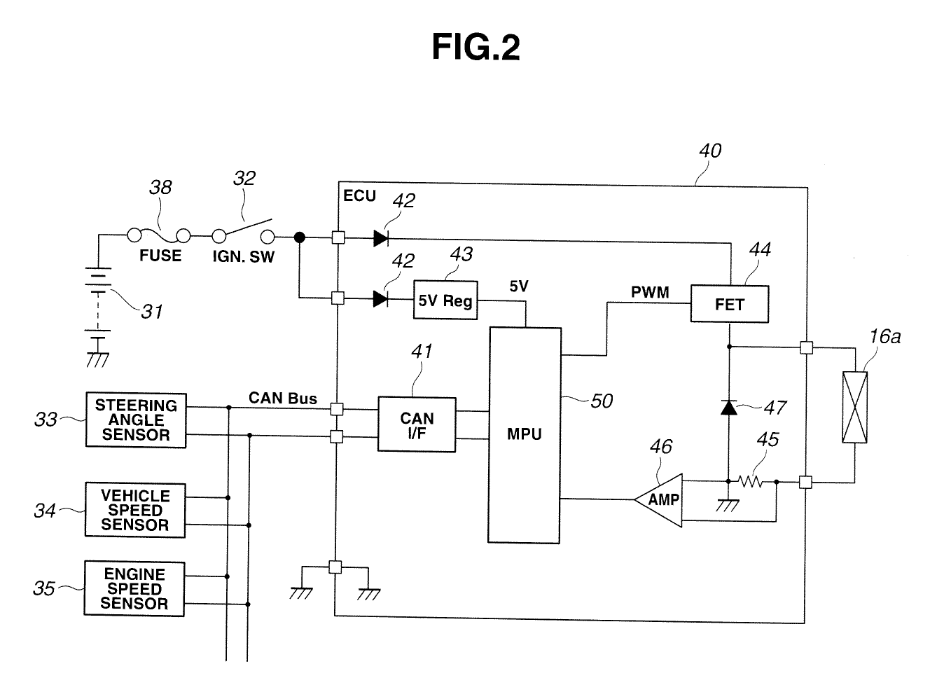

FIG. 2 schematically shows detailed device configuration of ECU 40. ECU 40 includes a microprocessor unit (MPU) 50 which controls electromagnetic valve 16. MPU 50 receives input of signals through a CAN interface 41 from sensors which measure operating states of the vehicle. The signals include a steering angle signal from steering angle sensor 33, a vehicle speed signal from vehicle speed sensor 34, and an engine speed signal from engine speed sensor 35. The steering angle signal indicates an angle of rotation of steering wheel 1 operated by an operator, and the vehicle speed signal indicates a travel speed of the vehicle. MPU 50 processes the signals, and then outputs a PWM drive control signal for driving the electromagnetic valve 16. MPU 50 is supplied with electric power from battery 31. The electric power is supplied through a fuse 38, an ignition switch 32, a diode 42, and a regulator 43. Regulator 43 regulates the battery voltage, which is normally equal to about 12 volt, to a voltage for driving the MPU 50, which is equal to 5 volt.

The PWM drive control signal is supplied to a field effect transistor (FET) 44 which performs switching. With reference to the PWM drive control signal, FET 44 switches the current supplied through the fuse 38, ignition switch 32, diode 42, and regulator 43 from battery 31, and supplies an excitation current to coil 16a of electromagnetic valve 16.

One end of coil 16a of electromagnetic valve 16 is connected to FET 44, whereas the other end of coil 16a is grounded through a resistance 45 which serves for current measurement. The voltage between the ends of resistance 45, which occurs according to the current flowing through the coil 16a, is amplified through an amplifier (AMP) 46, and then supplied as an actual supply current signal to MPU 50. Coil 16a is provided with a free wheel diode 47 arranged in parallel to coil 16a.

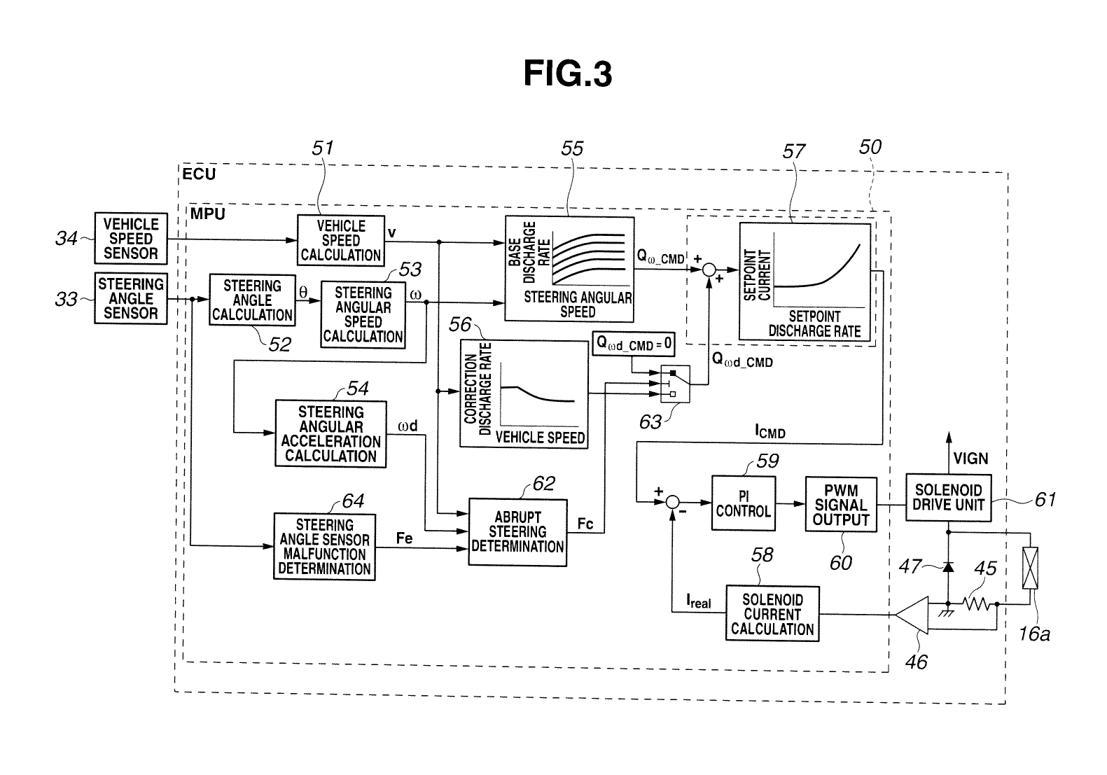

As shown in FIG. 3, MPU 50 includes a vehicle speed calculation section 51, a steering angle calculation section 52, a steering angular speed calculation section 53, a steering angular acceleration calculation section 54, a base discharge rate calculation section 55, a correction discharge rate calculation section 56, a setpoint current calculation section 57, a solenoid current calculation section 58, a PI control section 59, and a PWM signal output section 60. Vehicle speed calculation section 51 calculates vehicle speed V based on the vehicle speed signal from vehicle speed sensor 34. Steering angle calculation section 52 calculates steering angle θ based on the steering angle signal from steering angle sensor 33. Steering angular speed calculation section 53 calculates steering angular speed ω based on steering angle θ calculated by steering angle calculation section 52. Steering angular acceleration calculation section 54 calculates steering angular acceleration ωd based on steering angular speed ω calculated by steering angular speed calculation section 53. Base discharge rate calculation section 55 calculates base discharge rate Q_{ω}_{_{—}}_{CMD} based on steering angular speed ω calculated by steering angular speed calculation section 53 and vehicle speed V calculated by vehicle speed calculation section 51. Correction discharge rate calculation section 56 calculates correction discharge rate Q_{ωd}_{_{—}}_{CMD} based on vehicle speed V calculated by vehicle speed calculation section 51. Setpoint current calculation section 57 calculates setpoint discharge rate Q_{CMD} by adding correction discharge rate Q_{ωd}_{_{—}}_{CMD} calculated by correction discharge rate calculation section 56 to base discharge rate Q_{ω}_{_{—}}_{CMD} calculated by base discharge rate calculation section 55, and calculates setpoint current I_{CMD} based on setpoint discharge rate Q_{CMD} for achieving the setpoint discharge rate Q_{CMD}. The setpoint current I_{CMD} is a setpoint of the energizing current of electromagnetic valve 16 for achieving the setpoint discharge rate Q_{CMD}. Solenoid current calculation section 58 measures actual current Iᵣₑₐₗ flowing through the coil 16a. PI control section 59 calculates a PWM duty ratio by PI control (proportional-integral control) based on a difference between the setpoint current I_{CMD} calculated by setpoint current calculation section 57 and the actual current Iᵣₑₐₗ obtained by solenoid current calculation section 58. PWM signal output section 60 outputs a PWM drive control signal to FET 44 based on the PWM duty ratio calculated by PI control section 59.

Electromagnetic valve 16 is controlled through a solenoid drive unit 61 by FET 44 on the basis of the PWM duty ratio calculated by PI control section 59. Solenoid drive unit 61 has a function of shutting off its output when its temperature exceeds a predetermined threshold value, and a function of limiting the energizing current when an overcurrent flows through the solenoid drive unit 61.

Base discharge rate calculation section 55 implements the calculation of base discharge rate Q_{ω}_{_{—}}_{CMD} by calculating the base discharge rate Q_{ω}_{_{—}}_{CMD} based on vehicle speed V and steering angular speed ω by using a predetermined map. Base discharge rate calculation section 55 constitutes a base setpoint calculation circuit configured to calculate a base setpoint (Q_{ω}_{_{—}}_{CMD}) based on steering angular speed and vehicle speed, wherein the base setpoint gives a basis of the energizing current for controlling the electromagnetic valve 16. Vehicle speed V, steering angular speed ω, and base discharge rate Q_{ω}_{_{—}}_{CMD} have a relationship such that base discharge rate Q_{ω}_{_{—}}_{CMD} decreases as vehicle speed V increases, and such that base discharge rate Q_{ω}_{_{—}}_{CMD} increases as steering angular speed ω increases under constant vehicle speed.

Correction discharge rate calculation section 56 implements the calculation of correction discharge rate Q_{ωd}_{_{—}}_{CMD} by calculating the correction discharge rate Q_{ωd}_{_{—}}_{CMD} based on vehicle speed V by using a predetermined vehicle-speed-vs-correction-discharge-rate map as shown in FIG. 7. This map is defined basically such that correction discharge rate Q_{ωd}_{_{—}}_{CMD} decreases as vehicle speed V increases. Specifically, under a predetermined high speed drive condition in which vehicle speed V is greater than or equal to a first predetermined value V1, and under a predetermined low speed drive condition in which vehicle speed V is less than or equal to a second predetermined value V2 smaller than first predetermined value V1, correction discharge rate Q_{ωd}_{_{—}}_{CMD} is constant with respect to vehicle speed V. The predetermined low speed drive condition includes a condition in which the vehicle is stationary and vehicle speed V is equal to zero.

The basic feature of reducing the correction discharge rate Q_{ωd}_{_{—}}_{CMD} with increase in vehicle speed V, serves to produce a suitable assist steering torque in accordance with vehicle speed V while stabilizing the dynamic behavior of the vehicle against abrupt steering. The feature of holding the correction discharge rate Q_{ωd}_{_{—}}_{CMD} constant under the high speed drive condition where vehicle speed V is above first predetermined value V1, serves to enhance the steering stability and prevent the dynamic behavior of the vehicle from becoming unstable under the high speed drive condition. The feature of holding the correction discharge rate Q_{ωd}_{_{—}}_{CMD} constant, namely, maximized, under the low speed drive condition where vehicle speed V is below second predetermined value V2, serves to enhance the steering response under the low speed drive condition, because enhancement of the assist steering torque does not adversely affect the stability of the dynamic behavior of the vehicle under the low speed drive condition.

Setpoint current calculation section 57 implements the calculation of setpoint current I_{CMD} by adding the correction discharge rate Q_{ωd}_{_{—}}_{CMD} calculated by correction discharge rate calculation section 56 to the base discharge rate Q_{ω}_{_{—}}_{CMD} calculated by base discharge rate calculation section 55, and then calculating the setpoint current I_{CMD} by using a predetermined map. In this way, setpoint current calculation section 57 and correction discharge rate calculation section 56 constitute a control setpoint calculation circuit configured to calculate the control setpoint (Qₒᵤₜ, I_{CMD}) based on the base setpoint (Q_{ω}_{_{—}}_{CMD}) and steering angular acceleration (ωd) in a manner that the control setpoint (Qₒᵤₜ, I_{CMD}) increases more quickly than the base setpoint (Q_{ω}_{_{—}}_{CMD}) when the base setpoint (Q_{ω}_{_{—}}_{CMD}) increases in accordance with steering operation of the steering wheel (1).

MPU 50 further includes an abrupt steering determination section 62 as shown in FIG. 3. Abrupt steering determination section 62 determines whether or not abrupt steering is being made, based on vehicle speed V calculated by vehicle speed calculation section 51, and steering angular acceleration ωd calculated by steering angular acceleration calculation section 54. Abrupt steering determination section 62 is connected through a signal switching device 63 to correction discharge rate calculation section 56 and setpoint current calculation section 57. When determining that abrupt steering is being made, abrupt steering determination section 62 sets an abrupt steering flag Fc to “1” so that correction discharge rate Q_{ωd}_{_{—}}_{CMD} calculated by correction discharge rate calculation section 56 is outputted through the signal switching device 63 to setpoint current calculation section 57 without being corrected. On the other hand, when determining that abrupt steering is not being made, abrupt steering determination section 62 sets the abrupt steering flag Fc to “0” so that correction discharge rate Q_{ωd}_{_{—}}_{CMD} is set to zero at signal switching device 63 and then outputted to setpoint current calculation section 57.

MPU 50 further includes a steering angle sensor malfunction determination section 64 as shown in FIG. 3. Steering angle sensor malfunction determination section 64 is configured to determine whether or not steering angle sensor 33 is abnormal (or malfunctioning), based on the steering angle signal from steering angle sensor 33. The result of determination by steering angle sensor malfunction determination section 64 is outputted to abrupt steering determination section 62. When the abnormality of steering angle sensor 33 is affirmed, steering angle sensor malfunction determination section 64 sets a malfunction flag Fe to “1” so that the correction control is suspended. On the other hand, when the abnormality of steering angle sensor 33 is denied, namely, when the normality of steering angle sensor 33 is affirmed, steering angle sensor malfunction determination section 64 sets the malfunction flag Fe to “0” so that the correction control is continued. This feature of suspending the correction control based on steering angular acceleration ωd when steering angular acceleration ωd is an abnormal value, serves to achieve suitable pump control while ensuring the safety of the power steering system.

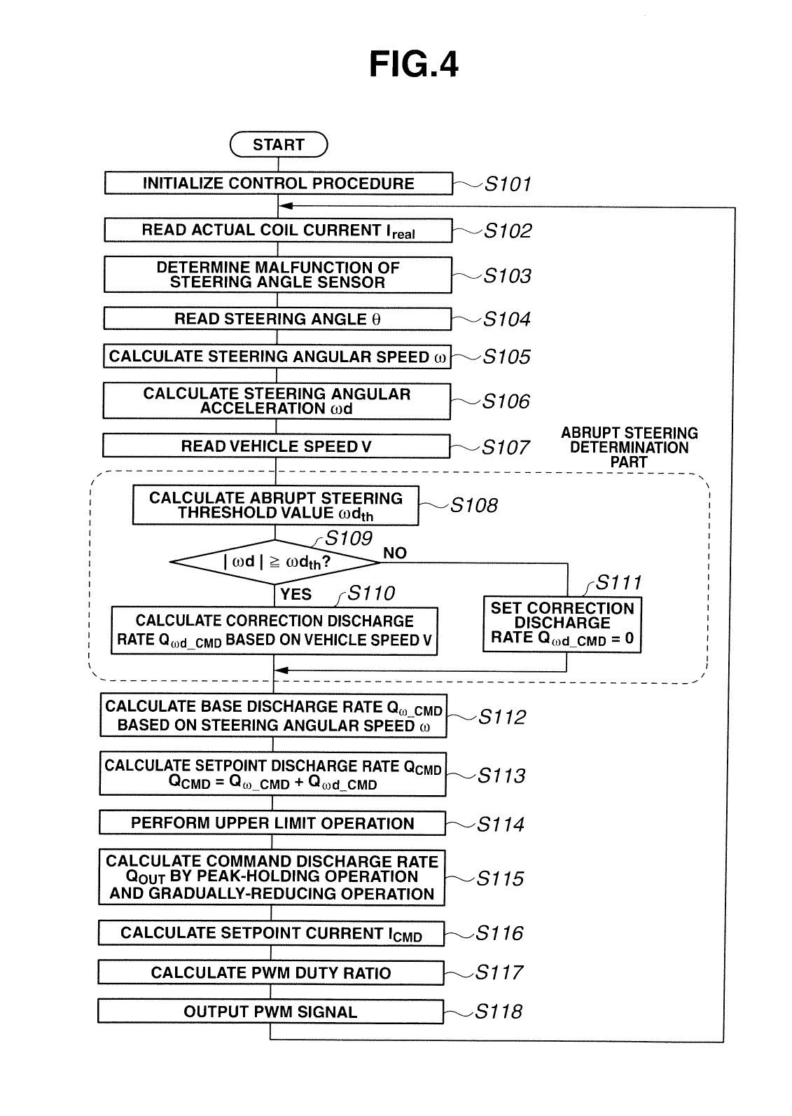

FIG. 4 shows a detailed control procedure of electromagnetic valve 16 by MPU 50 based on determination about abrupt steering.

At Step S101, MPU 50 initializes the control procedure. At Step S102, MPU 50 reads actual current Iᵣₑₐᵢ flowing through the coil 16a of electromagnetic valve 16. At Step S103, MPU 50 determines whether or not steering angle sensor 33 is failed, based on the steering angle signal from steering angle sensor 33. When determining that steering angle sensor 33 is failed, MPU 50 suspends the correction control, and then proceeds to Step S111. On the other hand, when determining that steering angle sensor 33 is normal, MPU 50 proceeds to Step S104. At Step S104, MPU 50 reads steering angle θ. At Step S105, MPU 50 calculates steering angular speed ω based on the read steering angle θ. At Step S106, MPU 50 calculates steering angular acceleration ωd based on the calculated steering angular speed ω. At Step S107, MPU 50 reads vehicle speed V, and then proceeds to a part handling the determination about abrupt steering.

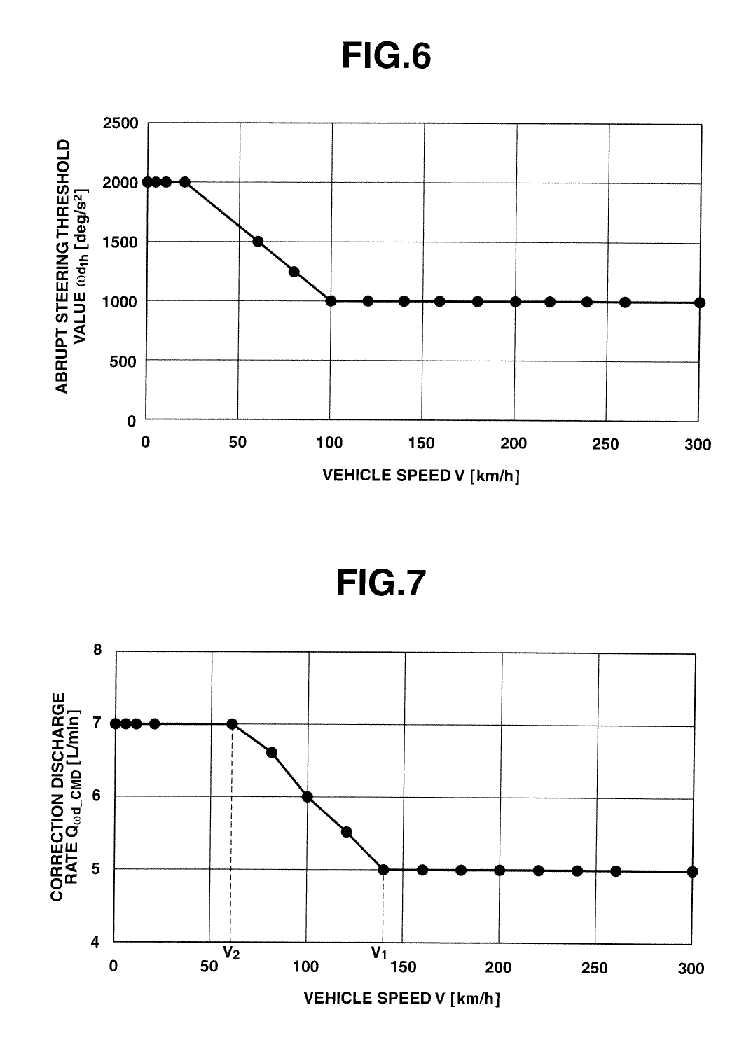

The part handling the determination about abrupt steering includes Steps S108 to S111. At Step S108, MPU 50 calculates abrupt steering threshold value ωdₜₕ based on vehicle speed V by using the map as shown in FIG. 6. At Step S109, MPU 50 determines whether or not the absolute value of steering angular acceleration ωd is greater than or equal to abrupt steering threshold value ωdₜₕ (|ωd|≧ωdₜₕ). When determining that the subject condition is satisfied, MPU 50 proceeds to Step S110 at which MPU 50 calculates correction discharge rate Q_{ωd}_{_{—}}_{CMD} according to vehicle speed V. On the other hand, when determining that the subject condition is unsatisfied, MPU 50 proceeds to Step S111 at which MPU 50 sets correction discharge rate Q_{ωd}_{_{—}}_{CMD} to zero.

After completing the determination about abrupt steering, MPU 50 calculates base discharge rate Q_{ω}_{_{—}}_{CMD} based on steering angular speed ω at Step S112. At Step S113, MPU 50 calculates setpoint discharge rate Q_{CMD} by adding the correction discharge rate Q_{ωd}_{_{—}}_{CMD} to base discharge rate Q_{ω}_{_{—}}_{CMD}. MPU 50 calculates a command discharge rate Qₒᵤₜ based on setpoint discharge rate Q_{CMD} through Steps S114 and S115, wherein command discharge rate Qₒᵤₜ is a final desired value of discharge rate of pump 10. At Step S114, MPU 50 performs an upper limit operation of setting the command discharge rate Qₒᵤₜ by limiting the setpoint discharge rate Q_{CMD} to an upper limit (or peak value or target value). At Step S115, when setpoint discharge rate Q_{CMD} has reached the upper limit, MPU 50 performs a peak-holding operation of holding the command discharge rate Qₒᵤₜ at the upper limit for a predetermined period of time and then performs a gradually reducing operation of gradually reducing the command discharge rate Qₒᵤₜ. At Step S116, MPU 50 calculates setpoint current I_{CMD} based on command discharge rate Qₒᵤₜ, wherein the energizing current is to be regulated or conformed to setpoint current I_{CMD}. At Step S117, MPU 50 calculates the PWM duty ratio by PI control with reference to the difference between setpoint current I_{CMD} and actual current Iᵣₑₐₗ. At Step S118, MPU 50 outputs a PWM drive signal to electromagnetic valve 16 based on the calculated PWM duty ratio, and then returns from this control procedure.

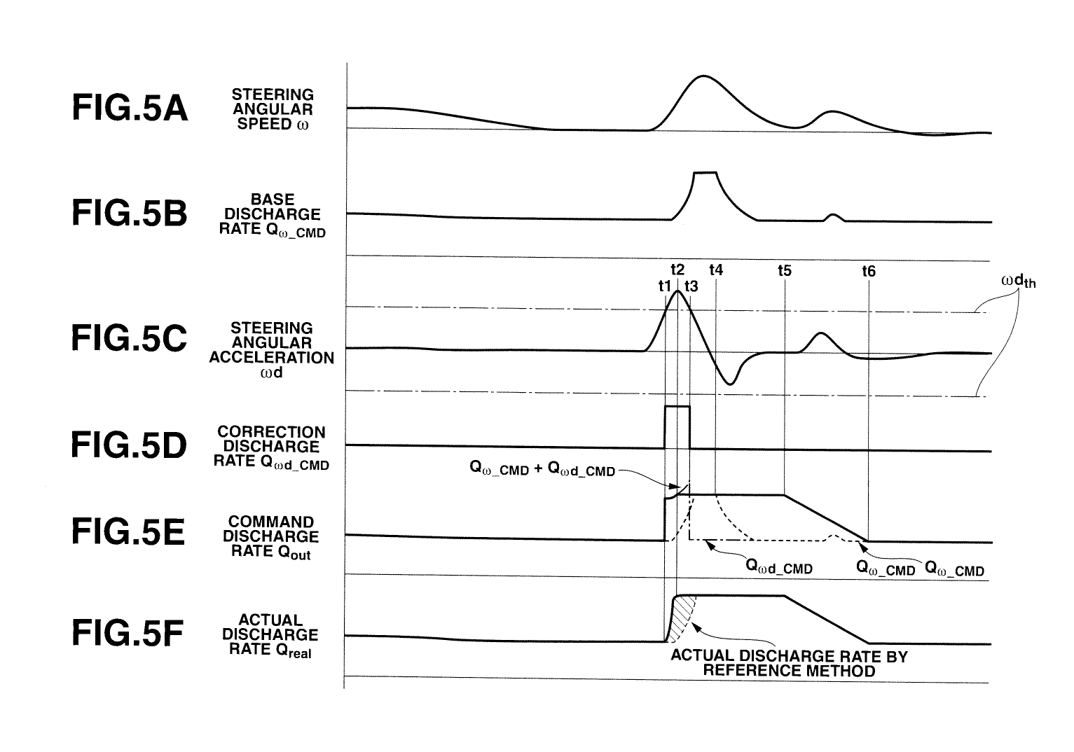

FIGS. 5A to 5F are a set of time charts showing an example of how various quantities change with time under control based on the control procedure of FIG. 4. At a time instant t1, it is determined by the abrupt steering determination operation that the absolute value of steering angular acceleration ωd exceeds the abrupt steering threshold value ωdₜₕ. After time instant t1, setpoint discharge rate Q_{CMD} is calculated by adding the correction discharge rate Q_{ωd}_{_{—}}_{CMD} to base discharge rate Q_{ω}_{_{—}}_{CMD} Immediately after time instant t1, command discharge rate Qₒᵤₜ is substantially equal to correction discharge rate Q_{ωd}_{_{—}}_{CMD}, because base discharge rate Q_{ω}_{_{—}}_{CMD}, which is calculated based on steering angular speed ω, is still small due to delay of control. This feature serves to quickly increase actual discharge rate Qᵣₑₐₗ as compared to cases in which command discharge rate Qₒᵤₜ is set to base discharge rate Q_{ω}_{_{—}}_{CMD} as indicated by broken lines about command discharge rate Qₒᵤₜ and actual discharge rate Qᵣₑₐₗ. Thereafter, as steering angular speed ω increases, base discharge rate Q_{ω}_{_{—}}_{CMD} increases, which is added to correction discharge rate Q_{ωd}_{_{—}}_{CMD} to increase command discharge rate Qₒᵤₜ. At a time instant t2 when command discharge rate Qₒᵤₜ reaches the upper limit or target value of base discharge rate Q_{ω}_{_{—}}_{CMD}, the peak-holding operation is started.

After time instant t2, the absolute value of steering angular acceleration ωd decreases below abrupt steering threshold value ωdₜₕ at a time instant t3 so that correction discharge rate Q_{ωd}_{_{—}}_{CMD} is set to zero. After time instant t3, command discharge rate Qₒᵤₜ is still held at the upper limit of base discharge rate Q_{ω}_{_{—}}_{CMD} by the peak-holding operation even with correction discharge rate Q_{ωd}_{_{—}}_{CMD} set to zero and even after a time instant t4 when base discharge rate Q_{ω}_{_{—}}_{CMD} decreases below the upper limit. At a time instant t5 when the predetermined period of time is elapsed after time instant t3 when the peak holding operation is started, the peak holding operation is terminated and the gradually reducing operation is started so that command discharge rate Qₒᵤₜ decreases gradually at the predetermined rate and reaches an initial value at a time instant t6, regardless of steering operation unless steering angular acceleration ωd exceeds abrupt steering threshold value ωdₜₕ again.

The variable displacement pump described above functions to correct the discharge rate of pump 10 based on steering angular acceleration ωd that reflects better the steering response desired by the driver, and increase the specific discharge rate of pump 10 more quickly than conventional systems in which the discharge rate is determined based on the steering angular speed ω. This serves to ensure a required discharge rate as shown by hatching pattern in FIG. 5F for actual discharge rate Qᵣₑₐₗ, and thereby satisfy driver's demand about steering response.

Namely, conditions where steering angular acceleration ωd is large indicate that the driver is making abrupt steering and desiring the discharge rate of pump 10 to be quickly increased. In this embodiment, the feature of setting the rate of change of setpoint discharge rate Q_{CMD} (or command discharge rate Qₒᵤₜ) higher than that of base discharge rate Q_{ω}_{_{—}}_{CMD}, based on determination whether or not steering angular acceleration ωd is above or below the abrupt steering threshold value ωdₜₕ, namely, the feature of controlling the control setpoint of the energizing current so that the control setpoint increases more quickly than the base setpoint, serves to increase the discharge rate of pump 10 more quickly as compared to conventional systems, and ensure high speed response in supplying working fluid to the power steering system.

Furthermore, according to the correction control described above, when steering angular acceleration ωd becomes greater than or equal to abrupt steering threshold value ωdₜₕ, the peak value or target value of setpoint discharge rate Q_{CMD} is equal to the peak value or target value of base discharge rate Q_{ω}_{_{—}}_{CMD}. Accordingly, the increment of setpoint discharge rate Q_{CMD} with respect to base discharge rate Q_{ω}_{_{—}}_{CMD} serves to enhance the response of electromagnetic valve 16, but maintains unchanged the level of the assist steering force with respect to steering operation. This achieves natural feeling of the driver about steering assist directed to steering operation.

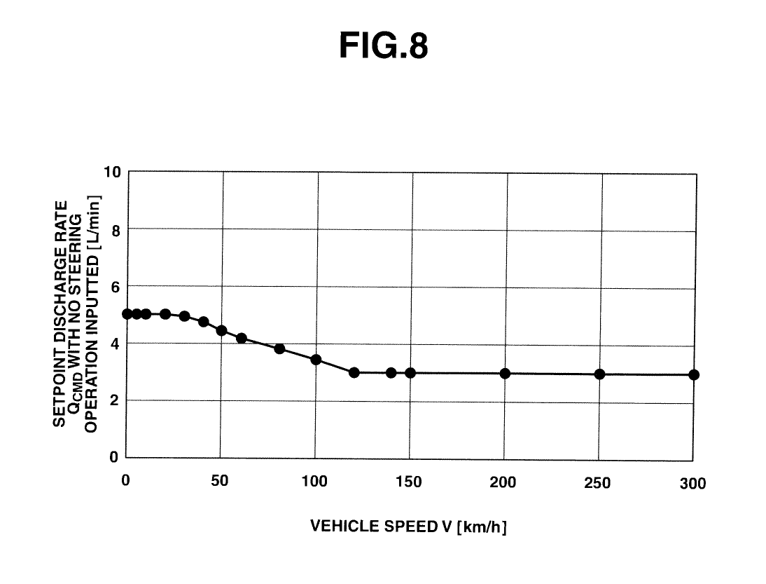

When the vehicle at rest and the engine is at idle and no steering operation of steering wheel 1 is inputted, the specific discharge rate of pump 10 is limited to 5 [litters/minute] as shown in FIG. 8. On the other hand, when steering wheel 1 is being operated, the specific discharge rate of pump 10 can be increased by a base discharge rate Q_{ω}_{_{—}}_{CMD} of 7 [litters/minute] at maximum. This feature serves to reduce the load of pump 10 while ensuring a sufficient assist steering torque when it is required in response to steering operation of steering wheel 1.

Furthermore, cam ring 14 is not directly driven by electromagnetic valve 16, but driven by driving the valve element 15a of control valve 15 by electromagnetic valve 16. This feature serves to reduce the mass of the object driven by electromagnetic valve 16, and thereby allow to quickly move the cam ring 14 by electromagnetic valve 16. Therefore, this feature serves to further enhance the steering response of the power steering system.

From the first embodiment is derived a variable displacement pump for supplying working fluid to a vehicle steering device (power cylinder 5 and the like), wherein the vehicle steering device (5) is configured to hydraulically generate an assist steering force in accordance with steering operation of a steering wheel (1), the variable displacement pump comprising: a pump housing (11) including a pumping part housing section (11a) inside the pump housing (11); a drive shaft (12) rotatably supported by the pump housing (11); a pumping part (13) housed in the pumping part housing section (11a) of the pump housing (11), and configured to suck and discharge working fluid by being rotated by the drive shaft (12); a cam ring (14) housed in the pumping part housing section (11a) of the pump housing (11), and arranged radially outside of the pumping part (13), and configured to move along with a change in eccentricity of the cam ring (14) with respect to an axis of rotation of the drive shaft (12), wherein the change in eccentricity causes a change in specific discharge rate, wherein the specific discharge rate is a quantity of discharge of working fluid per one rotation of the pumping part (13); a solenoid (electromagnetic valve 16) configured to control the eccentricity of the cam ring (14) by being driven with an energizing current (actual current Iᵣₑₐₗ) conformed to a control setpoint (command discharge rate Qₒᵤₜ or setpoint current I_{CMD}); a base setpoint calculation circuit (base discharge rate calculation section 55) configured to calculate a base setpoint (base discharge rate Q_{ω}_{_{—}}_{CMD}) based on steering angular speed (ω) and vehicle speed (V), wherein the steering angular speed (ω) is angular speed of rotation of the steering wheel (1); and a control setpoint calculation circuit (setpoint current calculation section 57) configured to calculate the control setpoint (Qₒᵤₜ, I_{CMD}) based on the base setpoint (Q_{ω}_{_{—}}_{CMD}) and steering angular acceleration (ωd) in a manner that the control setpoint (Qₒᵤₜ, I_{CMD}) increases more quickly than the base setpoint (Q_{ω}_{_{—}}_{CMD}) when the base setpoint (Q_{ω}_{_{—}}_{CMD}) increases in accordance with steering operation of the steering wheel (1), wherein the steering angular acceleration (ωd) is angular acceleration of rotation of the steering wheel (1). Also derived is a variable displacement pump further configured so that the control setpoint calculation circuit (setpoint current calculation section 57, abrupt steering determination section 62, signal switching device 63) is configured to: determine whether the steering angular acceleration (ωd) is above or below a predetermined threshold value (abrupt steering threshold value ωdₜₕ); and calculate the control setpoint (I_{CMD}) in a manner that the control setpoint (Qₒᵤₜ, I_{CMD}) increases more quickly when it is determined that the steering angular acceleration (ωd) is above the predetermined threshold value (ωdₜₕ) than when it is determined that the steering angular acceleration (ωd) is below the predetermined threshold value (ωdₜₕ). Also derived is a variable displacement pump further configured so that the drive shaft (12) is configured to be driven by an engine of a vehicle; and the solenoid (16) is configured to control the eccentricity of the cam ring (14) in a manner that the specific discharge rate is below a specific maximum setpoint when the engine is at idle and steering operation of the steering wheel (1) is absent.

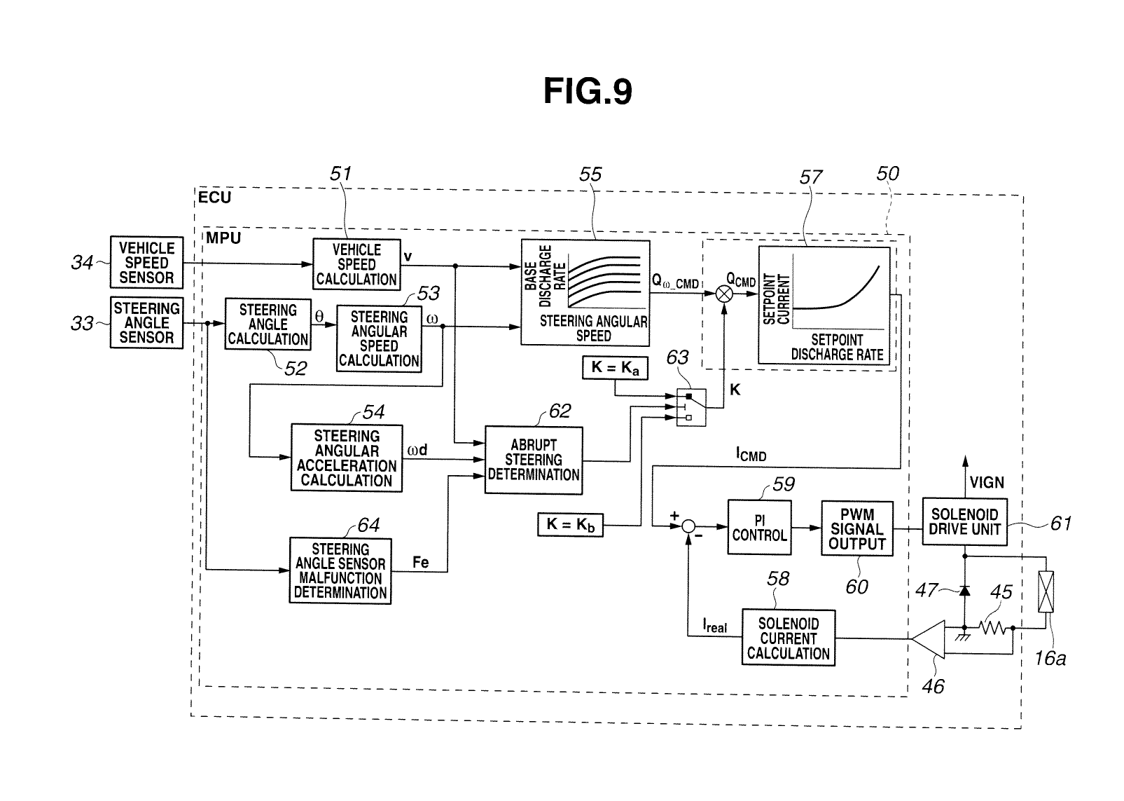

FIGS. 9 to 11E show a modification of the first embodiment, in which the abrupt steering determination operation is modified. Specifically, the correction to base discharge rate Q_{ω}_{_{—}}_{CMD} is implemented by multiplying the base discharge rate Q_{ω}_{_{—}}_{CMD} by a predetermined correction gain K in contrast to the first embodiment in which the correction is implemented by adding the correction discharge rate Q_{ωd}_{_{—}}_{CMD} to base discharge rate Q_{ω}_{_{—}}_{CMD}.

In this modification, as shown in FIG. 9, on the basis of the determination by abrupt steering determination section 62, signal switching device 63 switches the correction gain K between a first predetermined value Ka and a second predetermined value Kb, and outputs the set correction gain K. Setpoint current calculation section 57 multiplies the base discharge rate Q_{ω}_{_{—}}_{CMD} by correction gain K, and then calculates setpoint current I_{CMD} based on setpoint discharge rate Q_{CMD} by using the map as in the first embodiment.

Specifically, when abrupt steering determination section 62 determines that abrupt steering is present, abrupt steering flag Fc is set to “1” so that correction gain K is switched by signal switching device 63 to second predetermined value Kb (greater than first predetermined value Ka). This correction gain K is outputted to setpoint current calculation section 57 so that setpoint current I_{CMD} is calculated based on the value that is obtained by multiplying the base discharge rate Q_{ω}_{_{—}}_{CMD} by correction gain K. On the other hand, when abrupt steering determination section 62 determines that abrupt steering is absent, abrupt steering flag Fc is set to “0” so that correction gain K is switched by signal switching device 63 to first predetermined value Ka (equal to 1). This correction gain K is outputted to setpoint current calculation section 57 so that setpoint current I_{CMD} is calculated based on the value that is equal to base discharge rate Q_{ω}_{_{—}}_{CMD}.

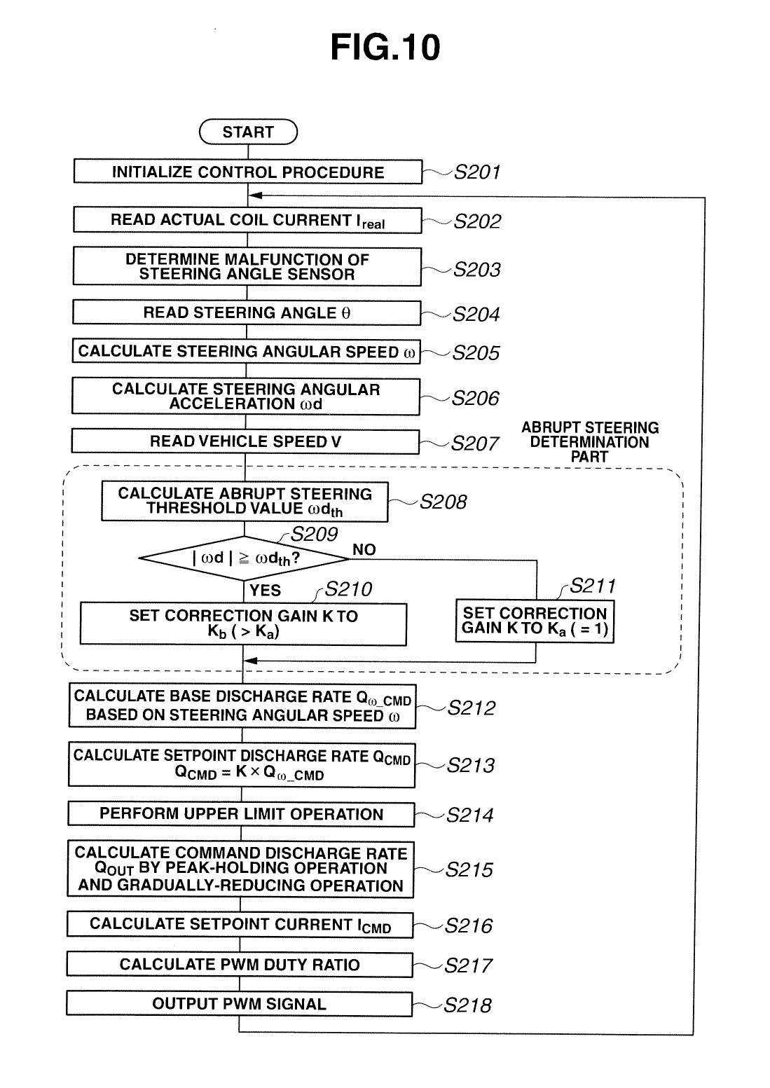

FIG. 10 is a flow chart showing a control procedure according to the modification of the first embodiment. Steps S201 to S208 are the same as Steps S101 to S108 in the first embodiment. When determining at Step S209 that it is satisfied that the absolute value of steering angular acceleration ωd is greater than or equal to abrupt steering threshold value ωdₜₕ, MPU 50 proceeds to Step S210 at which MPU 50 sets correction gain K to second predetermined value Kb (>Ka) and outputs same. On the other hand, when determining at Step S209 that it is unsatisfied that the absolute value of steering angular acceleration ωd is greater than or equal to abrupt steering threshold value ωdₜₕ, MPU 50 proceeds to Step S211 at which MPU 50 sets correction gain K to first predetermined value Ka (=1) and outputs same.

This abrupt steering determination operation described above is followed by Step S212 where MPU 50 calculates base discharge rate Q_{ω}_{_{—}}_{CMD} depending on steering angular speed ω as in the first embodiment. At Step S213, MPU 50 calculates setpoint discharge rate Q_{CMD} by multiplying the base discharge rate Q_{ω}_{_{—}}_{CMD} by correction gain K. Subsequently, Steps S214 to S218 are performed which are the same as Steps S114 to S118 in the first embodiment. Then, MPU 50 returns from this control procedure.

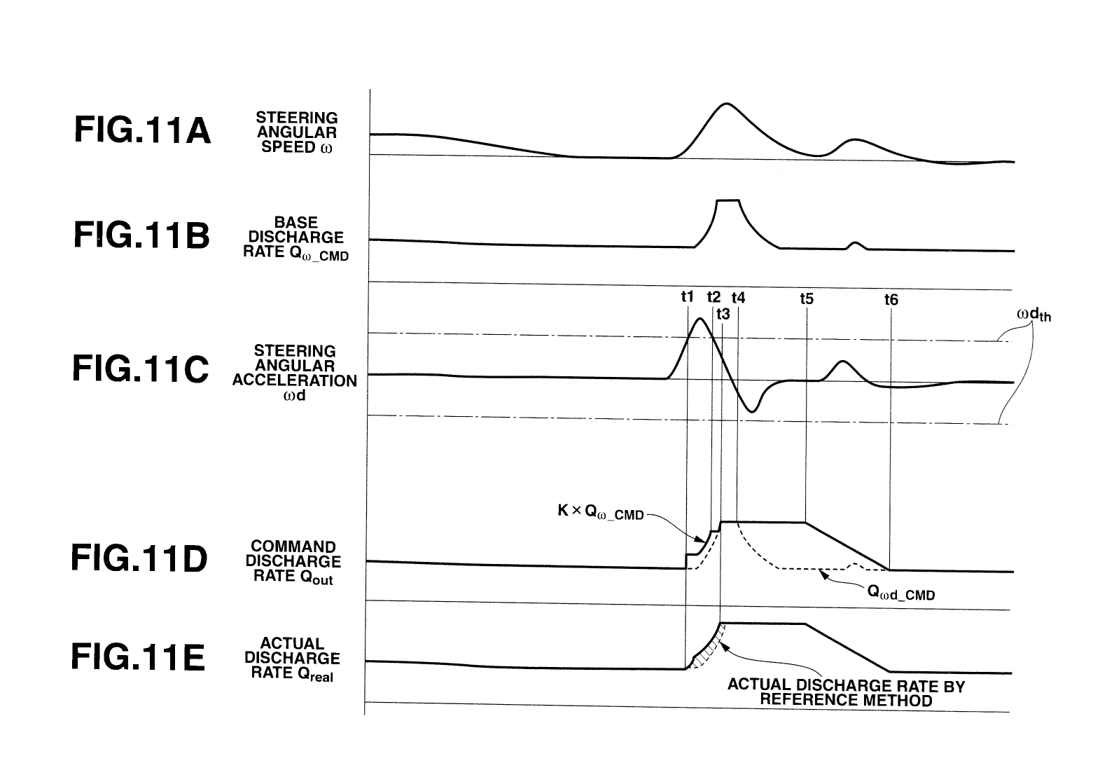

FIGS. 11A to 11E are a set of time charts showing an example of how various quantities change with time under control based on the control procedure of FIG. 10. After time instant t1 when the absolute value of steering angular acceleration ωd exceeds abrupt steering threshold value ωdₜₕ, base discharge rate Q_{ω}_{_{—}}_{CMD} is multiplied by second predetermined value Kb so that the multiplied base discharge rate Q_{ω}_{_{—}}_{CMD} is outputted as command discharge rate Qₒᵤₜ. This calculation of command discharge rate Qₒᵤₜ serves to achieve quick increase of actual discharge rate Qᵣₑₐₗ as shown in FIG. 11E, as compared to conventional cases in which actual discharge rate Qᵣₑₐₗ changes as a broken line in FIG. 11E.

Then, after time instant t2 when the absolute value of steering angular acceleration ωd becomes smaller than abrupt steering threshold value ωdₜₕ, base discharge rate Q_{ω}_{_{—}}_{CMD} is multiplied by correction gain K that is set to first predetermined value Ka of 1, and command discharge rate Qₒᵤₜ is maintained constant by the peak-holding operation. Thereafter, when base discharge rate Q_{ω}_{_{—}}_{CMD} reaches command discharge rate Qₒᵤₜ, command discharge rate Qₒᵤₜ starts to increase as base discharge rate Q_{ω}_{_{—}}_{CMD} increases in accordance with increase in steering angular speed ω. At time instant t3 when command discharge rate Qₒᵤₜ reaches the target value of base discharge rate Q_{ω}_{_{—}}_{CMD}, the peak-holding operation is started.

As in the first embodiment, after time instant t3, command discharge rate Qₒᵤₜ is still held at the target value of base discharge rate Q_{ω}_{_{—}}_{CMD} by the peak-holding operation even after a time instant t4 when base discharge rate Q_{ω}_{_{—}}_{CMD} decreases below the upper limit. At a time instant t5 when the predetermined period of time is elapsed after time instant t3 when the peak holding operation is started, the peak holding operation is terminated and the gradually reducing operation is started so that command discharge rate Qₒᵤₜ decreases gradually at the predetermined rate and reaches an initial value at a time instant t6, regardless of steering operation unless steering angular acceleration ωd exceeds abrupt steering threshold value ωdₜₕ again.

The variable displacement pump described above functions to correct the discharge rate of pump 10 based on steering angular acceleration ωd by multiplication by correction gain K instead of addition of correction discharge rate Q_{ωd}_{_{—}}_{CMD}, and increase the specific discharge rate of pump 10 more quickly than conventional systems in which the discharge rate is determined based on the steering angular speed ω. This serves to ensure a required discharge rate as shown by hatching pattern in FIG. 11E for actual discharge rate Qᵣₑₐₗ, and thereby satisfy driver's demand about steering response, as in the first embodiment.

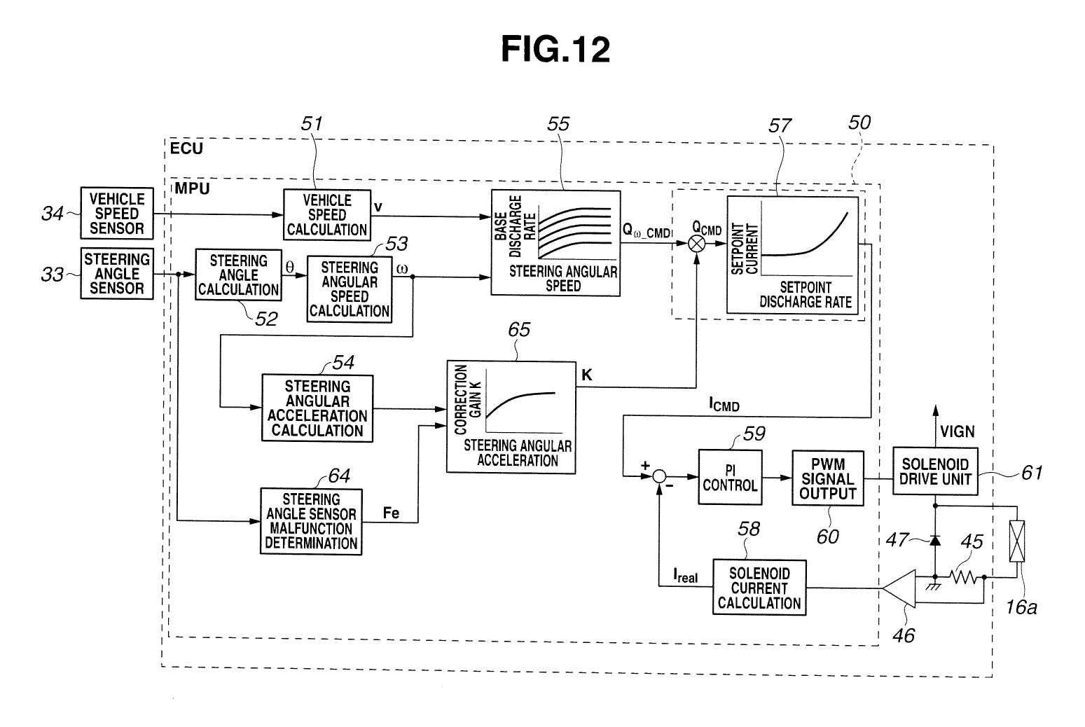

FIGS. 12 to 14 show a variable displacement pump according to a second embodiment of the present invention based on the modification of the first embodiment, in which the abrupt steering determination is replaced by a feature of calculating a correction gain K in accordance with steering angular acceleration ωd obtains setpoint discharge rate Q_{CMD} by multiplying the base discharge rate Q_{ω}_{_{—}}_{CMD} by correction gain K.

Specifically, abrupt steering determination section 62 is replaced by a correction gain calculation section 65 which is configured to calculate correction gain K in accordance with steering angular acceleration ωd that is calculated by steering angular acceleration calculation section 54. Correction gain calculation section 65 inputs the calculated correction gain K into setpoint current calculation section 57. Setpoint current calculation section 57 calculates setpoint discharge rate Q_{CMD} by multiplying the base discharge rate Q_{ω}_{_{—}}_{CMD} by correction gain K, and obtains setpoint current I_{CMD} based on setpoint discharge rate Q_{CMD} using the stored map, as in the modification of the first embodiment.

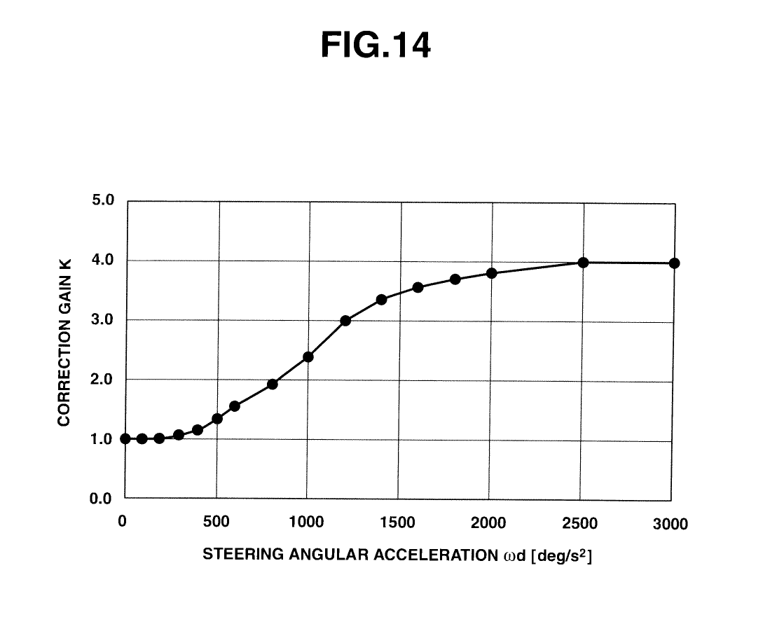

Correction gain K is obtained from a map as shown in FIG. 14, based on steering angular acceleration ωod that is calculated by steering angular acceleration calculation section 54. As shown in FIG. 14, correction gain K is set to increase as steering angular acceleration ωd increases.

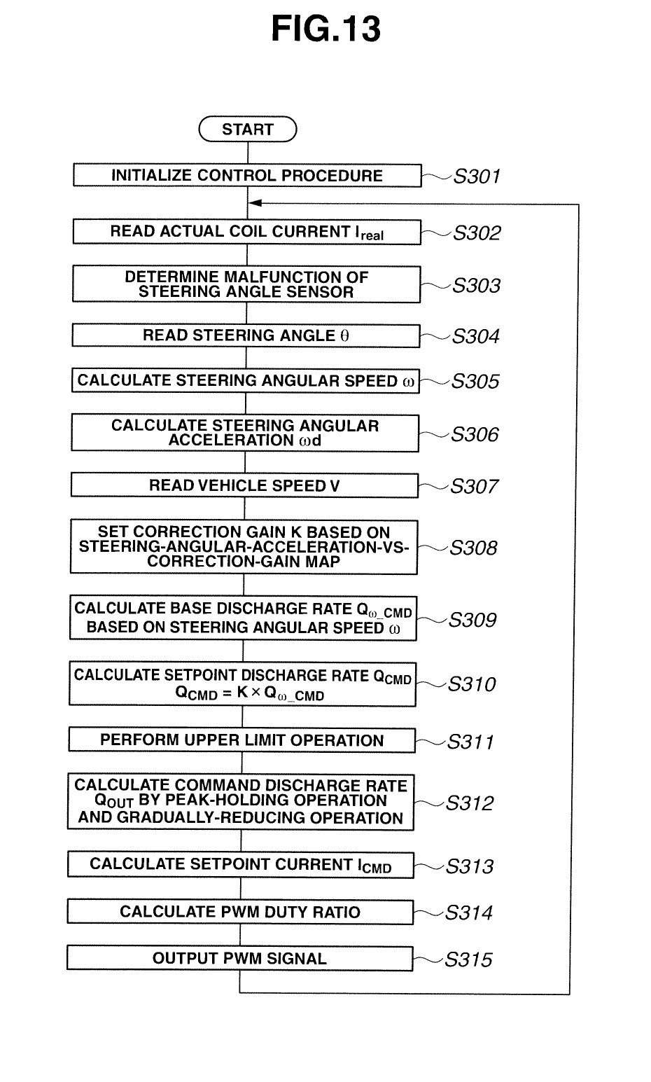

FIG. 13 shows a control procedure according to the second embodiment. At Step S301, MPU 50 initializes the control procedure. At Step S302, MPU 50 reads actual current Iᵣₑₐₗ flowing through the coil 16a of electromagnetic valve 16. At Step S303, MPU 50 determines whether or not steering angle sensor 33 is failed, based on the steering angle signal from steering angle sensor 33. When determining that steering angle sensor 33 is failed, MPU 50 suspends the correction control, and sets correction gain K to 1 with which the following steps are performed. On the other hand, when determining that steering angle sensor 33 is normal, MPU 50 proceeds to Step S304. At Step S304, MPU 50 reads steering angle θ. At Step S305, MPU 50 calculates steering angular speed ωbased on the read steering angle θ. At Step S306, MPU 50 calculates steering angular acceleration ωd based on the calculated steering angular speed ω.

At Step S308, MPU 50 calculates correction gain K based on vehicle speed V and steering angular acceleration ωd by using the steering-angular-acceleration-vs-correction-gain map as shown in FIG. 14. At Step S309, MPU 50 calculates base discharge rate Q_{ω}_{_{—}}_{CMD} based on steering angular speed ω. At Step S310, MPU 50 calculates setpoint discharge rate Q_{CMD} by multiplying the base discharge rate Q_{ω}_{_{—}}_{CMD} by correction gain K. Then, MPU 50 performs Steps S311 to S315 which are the same as Steps S214 to S218 of the modification of the first embodiment, and then returns from this control procedure.

The variable displacement pump described above functions to correct the discharge rate of pump 10 by multiplication by correction gain K based on steering angular acceleration ωd, without the abrupt steering determination based on steering angular acceleration ωd, and increase the specific discharge rate of pump 10 more quickly than conventional systems in which the discharge rate is determined based on the steering angular speed ω. This serves to ensure a required discharge rate.

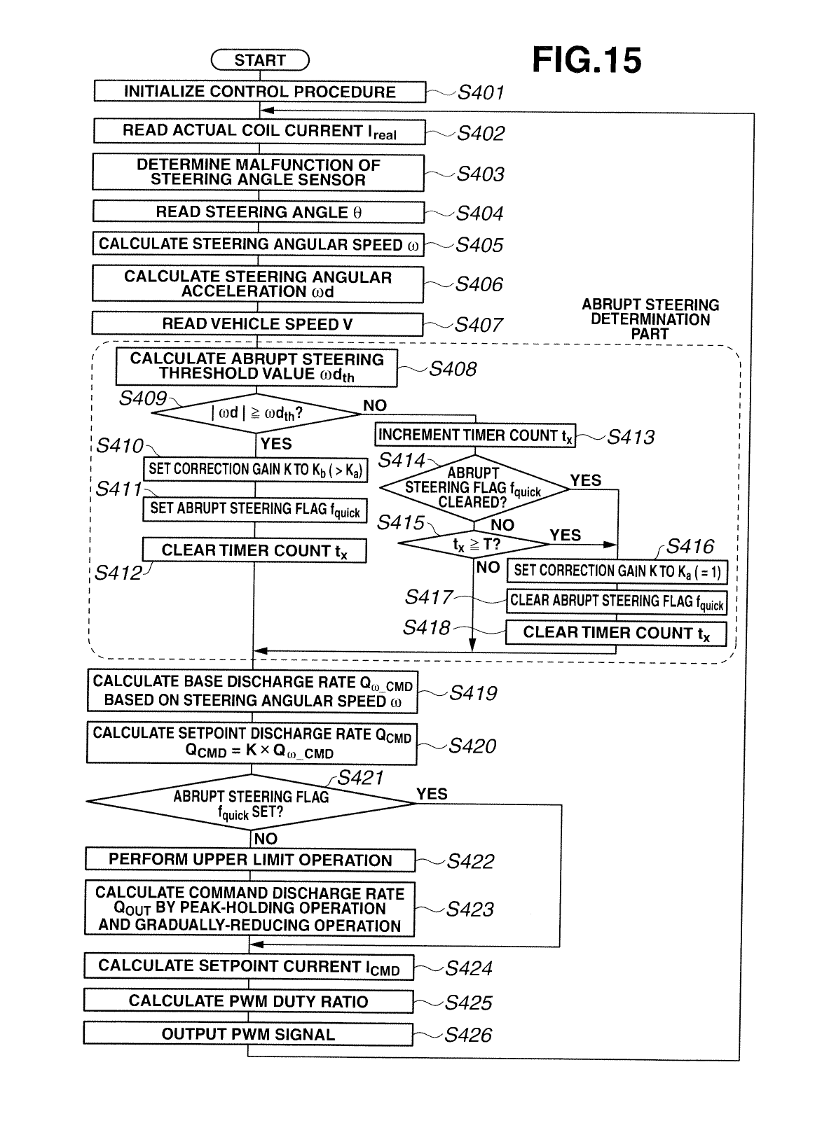

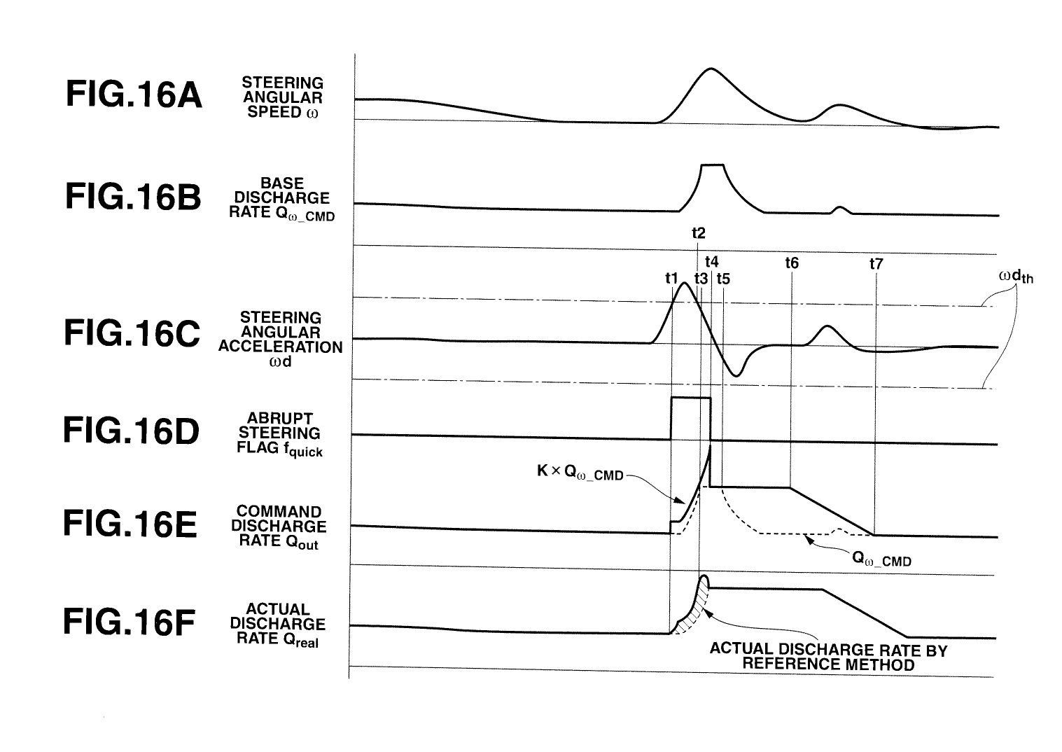

FIGS. 15 to 16F show a variable displacement pump according to a third embodiment of the present invention in which the abrupt steering determination according to the modification of the first embodiment is modified. The third embodiment is intended to continue the correction control even when abrupt steering is made repeatedly.

FIG. 15 shows a control procedure according to the third embodiment. Steps S401 to S409 are the same as Steps S201 to S209 of the modification of the first embodiment. When it is determined at Step S409 that the absolute value of steering angular acceleration ωd is greater than or equal to abrupt steering threshold value ωdₜₕ, MPU 50 sets correction gain K to second predetermined value Kb (>Ka), and outputs same at Step S410. At Step S411, MPU 50 sets an abrupt steering flag f_{quick}. At Step S412, MPU 50 clears a timer count tₓ.

On the other hand, when it is determined at Step S409 that the condition of|ωd|>=ωdₜₕ is unsatisfied, MPU 50 starts to increment the timer count tₓ at Step S413. Then, at Step S414, MPU 50 determines whether or not abrupt steering flag f_{quick} is cleared. When determining at Step S414 that abrupt steering flag f_{quick} is not cleared, MPU 50 determines at Step S415 whether or not a condition that timer count tₓ is greater than or equal to a predetermined time period T is satisfied. When determining at Step S415 that that condition is unsatisfied, MPU 50 proceeds to Step S419. On the other hand, when determining at Step S414 that abrupt steering flag f_{quick} is cleared, or when determining at Step S415 that timer count tₓ is greater than or equal to the predetermined time period T, MPU 50 sets correction gain K to first predetermined value Ka (=1) at Step S416, and clears abrupt steering flag f_{quick} at Step S417, and clears timer count tₓ at Step S418.

After the above abrupt steering determination, at Step S419, MPU 50 calculates base discharge rate Q_{ω}_{_{—}}_{CMD} based on steering angular speed w, and obtains setpoint discharge rate Q_{CMD} at Step S420 by multiplying the base discharge rate Q_{CMD} by correction gain K that is determined based on the abrupt steering determination. Then, at Step S421, MPU 50 checks whether or not abrupt steering flag f_{quick} is set. When determining that abrupt steering flag f_{quick} is not set, MPU 50 performs an upper limit operation at Step S422 as in the modification of the first embodiment, and then performs a peak holding operation for a predetermined period, and then performs a gradually reducing operation at Step S423. On the other hand, when it is determined at Step S421 that abrupt steering flag f_{quick} is set, ECU 40 skips Steps S422 and S423, and proceeds to Step S424. Then, MPU 50 performs Steps S424 to S426 which are the same as Step S216 to 218 of the modification of the first embodiment, and returns from this control procedure.

FIGS. 16A to 16F are a set of time charts showing an example of how various quantities change with time under control based on the control procedure of FIG. 15. After time instant t1 when the absolute value of steering angular acceleration ωd exceeds abrupt steering threshold value ωdₜₕ, base discharge rate Q_{ω}_{_{—}}_{CMD} is multiplied by second predetermined value Kb so that the multiplied base discharge rate Q_{ω}_{_{—}}_{CMD} is outputted as command discharge rate Qₒᵤₜ. This command discharge rate Qₒᵤₜ serves to achieve quick increase of actual discharge rate Qᵣₑₐₗ as shown in FIG. 16F, as compared to conventional cases in which actual discharge rate Qᵣₑₐₗ changes as a broken line in FIG. 16F.

Thereafter, after time instant t2 when the absolute value of steering angular acceleration ωd becomes smaller than abrupt steering threshold value ωdₜₕ, the correction control is continued until timer count tₓ reaches predetermined time period T, in contrast to the modification of the first embodiment in which the correction control is terminated. Accordingly, the correction control is continued when abrupt steering is made again before predetermined time period T is elapsed. Even if the command discharge rate Qₒᵤₜ reaches the target value of the base discharge rate Q_{ω}_{_{—}}_{CMD} at time instant t3, the command discharge rate Qₒᵤₜ continues to increase while abrupt steering flag f_{quick} is set. Accordingly, actual discharge rate Qᵣₑₐₗ is controlled to exceed the target value of base discharge rate Q_{ω}_{_{—}}_{CMD}.

At a time instant t4 when predetermined time period T is elapsed after time instant t2 when the absolute value of steering angular acceleration ωd decreases below abrupt steering threshold value ωdₜₕ, correction gain K is set to first predetermined value Ka (=1) so that command discharge rate Qₒᵤₜ is equal to base discharge rate Q_{ω}_{_{—}}_{CMD}, and abrupt steering flag f_{quick} is cleared so that the peak-holding operation is started. Then, as in the modification of the first embodiment, after time instant t4, command discharge rate Qₒᵤₜ is still held at the target value of base discharge rate Q_{ω}_{_{—}}_{CMD} by the peak-holding operation even after a time instant t5 when base discharge rate Q_{ω}_{_{—}}_{CMD} decreases below the target value. At a time instant t6 when the predetermined period of time is elapsed after time instant t4 when the peak holding operation is started, the peak holding operation is terminated and the gradually reducing operation is started so that command discharge rate Qₒᵤₜ decreases gradually at the predetermined rate and reaches an initial value at a time instant t7, regardless of steering operation unless steering angular acceleration ωd exceeds abrupt steering threshold value ωdₜₕ again.

The third embodiment described above serves to produce similar advantageous effects as the modification of the first embodiment, and further serves to allow command discharge rate Qₒᵤₜ to continue to increase until predetermined time period T is elapsed after steering angular acceleration ωd falls below abrupt steering threshold value ωdₜₕ, and allow the peak value of the setpoint discharge rate Q_{CMD} to exceed the target value of base discharge rate Q_{ω}_{_{—}}_{CMD} when steering angular acceleration ωd is greater than or equal to abrupt steering threshold value ωdₜₕ. This feature serves to further increase the assist steering force at the time of abrupt steering, and thereby further assist the abrupt steering operation.

Moreover, the feature of continuing the correction control until predetermined time period T is elapsed, serves to continue the correction control even when abrupt steering is made repeatedly. Accordingly, abrupt steering operation of the driver is suitably assisted.

The present embodiments may be modified in various manners. For example, abrupt steering threshold value ωdₜₕ, second predetermined value Kb, the period of the peak holding operation, the predetermined time period T, and the like may be set arbitrarily depending on specifications and the like of the power steering system.

The foregoing describes cases where the variable displacement pump is of a vane type with a cam ring. However, the variable displacement pump may be of another type if it is capable of controlling the discharge rate by using the electromagnetic valve 16.

The entire contents of Japanese Patent Application 2011-023523 filed Feb. 7, 2011 are incorporated herein by reference.

Although the invention has been described above by reference to certain embodiments of the invention, the invention is not limited to the embodiments described above. Modifications and variations of the embodiments described above will occur to those skilled in the art in light of the above teachings. The scope of the invention is defined with reference to the following claims.

What is claimed is:

1. A variable displacement pump for supplying working fluid to a vehicle steering device, wherein the vehicle steering device is configured to hydraulically generate an assist steering force in accordance with steering operation of a steering wheel, the variable displacement pump comprising:
a pump housing including a pumping part housing section inside the pump housing;
a drive shaft rotatably supported by the pump housing;
a pumping part housed in the pumping part housing section of the pump housing, and configured to suck and discharge working fluid by being rotated by the drive shaft;
a cam ring housed in the pumping part housing section of the pump housing, and arranged radially outside of the pumping part, and configured to move along with a change in eccentricity of the cam ring with respect to an axis of rotation of the drive shaft, wherein the change in eccentricity causes a change in specific discharge rate, wherein the specific discharge rate is a quantity of discharge of working fluid per one rotation of the pumping part;
a solenoid configured to control the eccentricity of the cam ring by being driven with an energizing current conformed to a control setpoint;
a base setpoint calculation circuit configured to calculate a base setpoint based on steering angular speed and vehicle speed, wherein the steering angular speed is angular speed of rotation of the steering wheel; and
a control setpoint calculation circuit configured to calculate the control setpoint based on the base setpoint and steering angular acceleration in a manner that the control setpoint increases more quickly than the base setpoint when the base setpoint increases in accordance with steering operation of the steering wheel, wherein the steering angular acceleration is angular acceleration of rotation of the steering wheel.

2. The variable displacement pump as claimed in claim 1, wherein the control setpoint calculation circuit is configured to:
determine whether the steering angular acceleration is above or below a predetermined threshold value; and
calculate the control setpoint in a manner that the control setpoint increases more quickly when it is determined that the steering angular acceleration is above the predetermined threshold value than when it is determined that the steering angular acceleration is below the predetermined threshold value.

3. The variable displacement pump as claimed in claim 2, wherein:
the drive shaft is configured to be driven by an engine of a vehicle; and
the solenoid is configured to control the eccentricity of the cam ring in a manner that the specific discharge rate is below a specific maximum setpoint when the engine is at idle and steering operation of the steering wheel is absent.

4. The variable displacement pump as claimed in claim 3, wherein the control setpoint calculation circuit is configured to calculate the control setpoint in a manner that the control setpoint exceeds a target value of the base setpoint when it is determined that the steering angular acceleration is above the predetermined threshold value.

5. The variable displacement pump as claimed in claim 3, wherein the control setpoint calculation circuit is configured to calculate the control setpoint in a manner that the control setpoint is limited to a target value of the base setpoint when it is determined that the steering angular acceleration is above the predetermined threshold value.

6. The variable displacement pump as claimed in claim 1, wherein the control setpoint calculation circuit is configured to calculate the control setpoint in a manner that a setpoint correction decreases with increase in the vehicle speed, wherein the setpoint correction is a difference between the control setpoint and the base setpoint.

7. The variable displacement pump as claimed in claim 6, wherein the control setpoint calculation circuit is configured to calculate the control setpoint in a manner that the setpoint correction is constant with respect to the vehicle speed when the vehicle speed is above a first predetermined value.

8. The variable displacement pump as claimed in claim 7, wherein the control setpoint calculation circuit is configured to calculate the control setpoint in a manner that the setpoint correction is constant with respect to the vehicle speed when the vehicle speed is below a second predetermined value smaller than the first predetermined value.

9. The variable displacement pump as claimed in claim 1, wherein the control setpoint calculation circuit is configured to:
determine whether the steering angular acceleration is abnormal; and
set the control setpoint equal to the base setpoint in response to determination that the steering angular acceleration is abnormal.

10. The variable displacement pump as claimed in claim 1, further comprising:
a discharge passage formed in the pump housing, wherein working fluid discharged by the pumping part flows through the discharge passage;
a first fluid pressure chamber defined in the pumping part housing section of the pump housing radially outside of the cam ring, wherein the first fluid pressure chamber contracts along with movement of the cam ring in a direction to increase the specific discharge rate;
a second fluid pressure chamber defined in the pumping part housing section of the pump housing radially outside of the cam ring, wherein the second fluid pressure chamber expands along with movement of the cam ring in the direction to increase the specific discharge rate;
a variable metering orifice provided in the discharge passage, and configured to vary a cross-sectional flow area of the discharge passage by operation of the solenoid; and
a control valve housed in the pump housing, and configured to be driven by a differential pressure of working fluid between upstream and downstream sides of the variable metering orifice in the discharge passage.

11. A variable displacement pump for supplying working fluid to a vehicle steering device, wherein the vehicle steering device is configured to hydraulically generate an assist steering force in accordance with steering operation of a steering wheel, the variable displacement pump comprising:
a pump housing including a pumping part housing section inside the pump housing;
a drive shaft rotatably supported by the pump housing;
a pumping part housed in the pumping part housing section of the pump housing, and configured to suck and discharge working fluid by being rotated by the drive shaft;
a cam ring housed in the pumping part housing section of the pump housing, and arranged radially outside of the pumping part, and configured to move along with a change in eccentricity of the cam ring with respect to an axis of rotation of the drive shaft, wherein the change in eccentricity causes a change in specific discharge rate, wherein the specific discharge rate is a quantity of discharge of working fluid per one rotation of the pumping part; and
a solenoid configured to control the eccentricity of the cam ring by being driven with an energizing current conformed to a control setpoint, wherein:
a base setpoint is calculated based on steering angular speed and vehicle speed, wherein the steering angular speed is angular speed of rotation of the steering wheel; and
the control setpoint is calculated based on the base setpoint and steering angular acceleration in a manner that the control setpoint increases more quickly than the base setpoint when the base setpoint increases in accordance with steering operation of the steering wheel, wherein the steering angular acceleration is angular acceleration of rotation of the steering wheel.

12. The variable displacement pump as claimed in claim 11, further comprising a control setpoint calculation circuit, wherein the control setpoint calculation circuit is configured to:
determine whether the steering angular acceleration is above or below a predetermined threshold value; and
calculate the control setpoint in a manner that the control setpoint increases more quickly when it is determined that the steering angular acceleration is above the predetermined threshold value than when it is determined that the steering angular acceleration is below the predetermined threshold value.

13. The variable displacement pump as claimed in claim 12, wherein:
the drive shaft is configured to be driven by an engine of a vehicle; and
the solenoid is configured to control the eccentricity of the cam ring in a manner that the specific discharge rate is below a specific maximum setpoint when the engine is at idle and steering operation of the steering wheel is absent.

14. The variable displacement pump as claimed in claim 13, wherein the control setpoint calculation circuit is configured to calculate the control setpoint in a manner that the control setpoint exceeds a target value of the base setpoint when it is determined that the steering angular acceleration is above the predetermined threshold value.

15. The variable displacement pump as claimed in claim 13, wherein the control setpoint calculation circuit is configured to calculate the control setpoint in a manner that the control setpoint is limited to a target value of the base setpoint when it is determined that the steering angular acceleration is above the predetermined threshold value.

16. A variable displacement pump for supplying working fluid to a vehicle steering device, wherein the vehicle steering device is configured to hydraulically generate an assist steering force in accordance with steering operation of a steering wheel, the variable displacement pump comprising:
a pump housing including a pumping part housing section inside the pump housing;
a drive shaft rotatably supported by the pump housing;
a pumping part housed in the pumping part housing section of the pump housing, and configured to suck and discharge working fluid by being rotated by the drive shaft;
a cam ring housed in the pumping part housing section of the pump housing, and arranged radially outside of the pumping part, and configured to move along with a change in eccentricity of the cam ring with respect to an axis of rotation of the drive shaft, wherein the change in eccentricity causes a change in specific discharge rate, wherein the specific discharge rate is a quantity of discharge of working fluid per one rotation of the pumping part;
a solenoid configured to control the eccentricity of the cam ring by being driven with an energizing current conformed to a control setpoint;
a base setpoint calculation circuit configured to calculate a base setpoint based on steering angular speed and vehicle speed, wherein the steering angular speed is angular speed of rotation of the steering wheel; and
a control setpoint calculation circuit configured to:
determine whether the steering angular acceleration is above or below a predetermined threshold value; and
calculate the control setpoint in a manner that the control setpoint increases more quickly when it is determined that the steering angular acceleration is above the predetermined threshold value than when it is determined that the steering angular acceleration is below the predetermined threshold value.

17. The variable displacement pump as claimed in claim 16, wherein:
the drive shaft is configured to be driven by an engine of a vehicle; and
the solenoid is configured to control the eccentricity of the cam ring in a manner that the specific discharge rate is below a specific maximum setpoint when the engine is at idle and steering operation of the steering wheel is absent.

18. The variable displacement pump as claimed in claim 17, wherein the control setpoint calculation circuit is configured to calculate the control setpoint in a manner that the control setpoint exceeds a target value of the base setpoint when it is determined that the steering angular acceleration is above the predetermined threshold value.

19. The variable displacement pump as claimed in claim 17, wherein the control setpoint calculation circuit is configured to calculate the control setpoint in a manner that the control setpoint is limited to a target value of the base setpoint when it is determined that the steering angular acceleration is above the predetermined threshold value.

20. The variable displacement pump as claimed in claim 16, wherein the control setpoint calculation circuit is configured to calculate the control setpoint in a manner that a setpoint correction decreases with increase in the vehicle speed, wherein the setpoint correction is a difference between the control setpoint and the base setpoint.
